(19) United States
(12) Patent Application Publication
(10) Pub. No.: US 2002/0132118 A1
(43) Pub. Date: Sep. 19, 2002

(54) Photocurable resin composition

(76) Inventors: Tsuyoshi Hirai, Mie (JP); Zen Komiya, Ibaraki (JP); Takashi Ukachi, Ushiku (JP)

Correspondence Address: PILLSBURY WINTHROP, LLP, P.O. BOX 10500, MCLEAN, VA, 22102, US

(21) Appl. No.: 09/755,188

(22) Filed: Jan. 8, 2001

Related U.S. Application Data
(63) Continuation of application No. PCT/NL99/00423, filed on Jul. 5, 1999.

(30) Foreign Application Priority Data
Jul. 8, 1998 (JP) H10-193104

(51) Int. Cl. D02G 3/00; C08G 18/00

(52) U.S. Cl. 428/375; 521/159

(57) ABSTRACT

A photocurable resin composition with small water absorption, low viscosity, and high curing speed, which is suitable as a coating material for optical fibers. The photocurable resin composition comprising a urethane (meth)acrylate as a polymerizable component, wherein part or all of the urethane (meth)acrylate is produced from 12-hydroxystearic acid triglyceride.

### FIELD OF THE INVENTION

The present invention relates to a photocurable resin composition and, more particularly, to a photocurable resin composition having low viscosity and exhibiting a high curing speed, while producing cured products with small water absorption. In particular, the curable composition of the present invention is a liquid curable composition that can be formulated for use in a wide variety of applications including, for example, coatings and/or binders. In particular, these curable compositions offer relatively fast cure speeds which offer advantages in many applications such as in the production of fiber optics wherein production speeds make it desirable to utilize primary coatings, secondary coatings (including, for example transparent and/or colored secondary coatings), inks, matrix materials and/or bundling materials that can be cured rapidly.

### BACKGROUND OF THE INVENTION

In the production of optical fibers, a resin coating is provided for protection and reinforcement immediately after spinning molten glass fibers. A known structure of the resin coating consists of a primary coating layer of a flexible resin coated on the surface of the optical fibers and a secondary coating layer of a rigid resin provided over the primary coating layer. A so-called optical fiber ribbon has been known in the art in the application of optical fibers provided with a resin coating. The optical fiber ribbon is made from several optical fibers (e.g. four or eight optical fibers) by arranging these fibers in a plane and securing them with a binder to produce a ribbon structure with a rectangular cross section. A method for fabricating a multi-core structure by bundling two or more such ribbons has also been known in the art. For example, two ribbons each consisting of four optical fibers are covered altogether with the binder to form a ribbon with eight optical fibers. A resin composition for forming the primary coating layer is called a primary coating; a resin composition for forming the secondary coating layer is called a secondary coating; a material for producing the optical fiber ribbon structure from several optical fibers is called a ribbon matrix material; and a material for further binding several optical fiber ribbons to produce multi-core optical fiber ribbons is called a bundling material. Often, the fibers for identification purposes will be further coated with an ink, which is a curable resin comprising a colorant (such as a pigment and/or a dye), or the secondary coating may be a colored secondary coating (i.e, comprise a colorant).

Photocurable compositions have conventionally been used as a resin composition for optical fiber coatings in view of high productivity. A typical composition comprises a urethane (meth)acrylate, (meth)acrylate monomer (a relatively low molecular weight compound containing no urethane bonds), reactive diluent, and photopolymerization initiator. The urethane (meth)acrylate is produced from a polyol such as a polyether diol, polyester polyol, and polycarbonate polyol, a diisocyanate, and a hydroxyl group-containing (meth)acrylate.

Optical fiber cables in which optical fibers are enclosed are frequently installed underground or outdoors. Such optical fiber cables and glass fibers enclosed therein are apt to deteriorate when underground water or rain invades the cables. To overcome such a problem, optical fiber coating materials having a low water absorption have been desired.

Moreover, the optical fibers manufacturing speed has been doubled in recent years due to a drastic increase in the demand for optical fibers. Curable resin materials with low viscosity and a high curing speed have been used as the secondary coatings, ribbon matrix materials, or bundling materials for such optical fibers to ensure high productivity of optical fibers.

An object of the present invention is to provide a photocurable resin composition with a low water absorption, low viscosity, and high curing speed.

Other objects and advantages of the present invention will become apparent from the following description of the invention.

### SUMMARY OF THE INVENTION

The above object and advantage can be achieved in the present invention by a photocurable composition comprising a (meth)acrylate urethane compound derived at least in part from at least one fatty acid glyceride compound wherein said glyceride compound comprises on average at least 1.5 hydroxy groups.

The curable composition of the present invention may be formulated for use in a wide variety of applications including, for example, coatings and/or binders. In particular, these curable compositions offer relatively fast cure speeds which offer advantages in many application such as in the production of fiber optics wherein production speeds make it desirable to utilize primary coatings, secondary coatings (including, for example transparent and/or colored secondary coatings), inks, matrix materials and/or bundling materials that can be cured rapidly.

A method for forming the curable composition of the present invention comprising a process for forming the urethane compound by reacting

(a) a fatty acid glyceride,

(b) a polyisocyanate, and

(c) a (meth)acrylate containing a hydroxyl group,

wherein the process includes (i) reacting the glyceride, the polyisocyanate, and the hydroxyl group-containing (meth)acrylate altogether; (ii) reacting the glyceride and the polyisocyanate, and reacting the resulting product with the hydroxyl group-containing (meth)acrylate; (iii) reacting the polyisocyanate and the hydroxyl group-containing (meth)acrylate, and reacting the resulting product with the glyceride; and (iv) reacting the polyisocyanate and the hydroxyl group-containing (meth)acrylate, reacting the resulting product with the glyceride, and reacting the hydroxyl group-containing (meth)acrylate once more.

### DETAILED DESCRIPTION OP PREFERRED EMBODIMENTS

(Meth) acrylic as used herein is understood to represent separately and collectively acrylic, methacrylic and mixtures thereof. Similarly, (meth)acrylate as used herein is understood to represent separately and collectively acrylate, (meth)acrylate, and mixtures thereof.

Many conventional photocurable compositions for optical fiber coatings comprise a urethane (meth)acrylate. Conventional urethane (meth)acrylate compounds may be manufactured from a polyol compound (such as a polyether diol, polyester polyol, or polycarbonate polyol), a diisocyanate compound, and a (meth)acrylate containing a hydroxyl group (hereinafter called a hydroxyl group-containing (meth)acrylate).

The urethane (meth)acrylate of the present invention is prepared from a fatty acid glyceride compound wherein said glyceride compound comprises at least on average at least 1.5 hydroxy groups, preferably from 2 to 8, and more preferably from 2 to 5 hydroxy groups. In addition, the preferred urethane (meth)acrylate compounds of the present invention include between 1 and 8 ethylenically unsaturated groups, more preferably between 2 and 5, and most prefered between 2.5 and 3 of such groups.

The urethane (meth)acrylate compound of the present invention is prepared by reacting a fatty acid glyceride, such as, for example, a 12-hydroxystearic acid triglyceride, a diisocyanate, and a hydroxyl group containing (meth)acrylate. This reaction comprises the reaction of at least one of the isocyanate groups on a diisocyanate compound and a hydroxyl group of the 12-hydroxystearic acid triglyceride and the reaction of an isocyanate group of the diisocyanate compound and a hydroxyl group of the hydroxyl group-containing (meth)acrylate compound. The reaction product is a polyfunctional compound having a structure in which the residue of the 12-hydroxystearic acid triglyceride is linked via a urethane group with at least one group-containing (meth)acrylate. Specifically, such a compound has a structure in which part or all of hydroxyl groups of the 12-hydroxystearic acid triglyceride are substituted by a urethane (meth)acrylate group with a structure of the following formula (1):

—OCONH—R¹—NHCOO—R² (1)

wherein R¹ is a residual group of the diisocyanate compound from which two isocyanate groups are removed and R² is a residual group of the hydroxyl group-containing (meth)acrylate compound from which hydroxyl groups are removed.

Examples of processes for reacting these compounds include reacting the glyceride, diisocyanate, and hydroxyl group-containing (meth)acrylate altogether; reacting the glyceride and diisocyanate first, and then reacting the resulting product with the hydroxyl group-containing (meth)acrylate; reacting diisocyanate and hydroxyl group containing (meth)acrylate first and then reacting the resulting product with glyceride; and the like can be given.

The glyceride preferably includes fatty acid glycerides, in particular, glycerides of fatty acids such as stearic acid, linolic acid, oleic acid, palmatic acid, ricinolic acid and/or mixtures thereof. Preferred fatty acid glycerides include those comprising three fatty acid moieties (i.e., moieties derived from fatty acid groups). The preferred glycerides include those that have been hydrogenated, in particular, those that have been hydrogenated to a hydrogenation rate of 20% or more, preferably 50% or more, more preferably 80% or more, and ideally 90% or more.

A preferred glyceride includes a glyceride represented by the following formula (2):

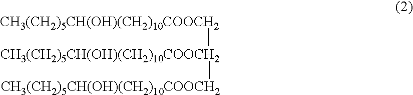

The (meth)acrylate urethane compound is preferably derived from a hydrogenated castor oil, comprising the at least one glyceride. Hydrogenated castor oil produced by hydrogenating castor oil is preferably used as the 12-hydroxystearic acid triglyceride.

Castor oil is an oil containing a glyceride of ricinolic acid in an amount from about 87-91% and glycerides of other fatty acids such as linolic acid, oleic acid, and palmitic acid. A ricinolic acid glyceride, which is the major component, is a compound having three hydroxyl groups. Hydrogenated castor oil is prepared by hydrogenating the castor oil to decrease the unsaturated double bonds contained therein. The hydrogenated castor oil is commercially available under the trademarks, for example, Castor Wax, Castor Wax B (manufactured by Itoh Oil Manufacturing Co., Ltd.), Hydrogenated Castor, Hydrogenated Castor B, K-3-Wax, K-3-Wax-500 (manufactured by Kawaken Fine Chemicals Co. Ltd.), and Castor Wax A (manufactured by Nippon Oil and Fats Co., Ltd.). The 12-hydroxystearic acid triglyceride used in the present invention is hydrogenated castor oil with a hydrogenation rate of 20% or more, preferably 50% or more, more preferably 80% or more, and ideally 90% or more. Too small a hydrogenation rate is not desirable because the resulting composition of the present invention exhibits only a low curing speed.

The proportion of the glyceride, diisocyanate, and hydroxyl group-containing (meth)acrylate used in the preparation of the urethane (meth)acrylate containing glyceride residues is determined so that for one mol of the hydroxyl group included in the glyceride, 0.2 to 3 mols, preferably 1 to 2 mols, of isocyanate group included in the diisocyanate compound and 0.2 to 1.5 mols, preferably 0.5 to 1 mol, of the hydroxyl group included in the hydroxyl group-containing (meth)acrylate compounds are used.

Given as examples of the diisocyanate compounds used for the preparation of the urethane (meth)acrylate containing the 12-hydroxystearic acid triglyceride or hydrogenated castor oil as a raw material are 2,4-tolylene diisocyanate, 2,6-tolylene diisocyanate, 1,3-xylylene diisocyanate, 1,4-xylylene diisocyanate, 1,5-naphthalene diisocyanate, m-phenylene diisocyanate, p-phenylene diisocyanate, 3,3′-dimethyl-4,4′-diphenylmethane diisocyanate, 4,4′-diphenylmethane diisocyanate, 3,3′-dimethylphenylene diisocyanate, 4,4′-biphenylene diisocyanate, 1,6-hexane diisocyanate, isophorone diisocyanate, methylenebis(4-cyclohexyl isocyanate), 2,2,4-trimethylhexamethylene diisocyanate, bis(2-isocyanatethyl)fumarate, 6-isopropyl-1,3-phenyl diisocyanate, 4-diphenylpropane diisocyanate, lysine diisocyanate, hydrogenated diphenylmethane diisocyanate, hydrogenated xylylene diisocyanate, and tetramethylxylylene diisocyanate. Of these, 2,4-tolylene diisocyanate, isophorone diisocyanate, xylylene diisocyanate, methylene bis(4-cyclohexyl isocyanate), and the like are desirable. These diisocyanate compounds may be used either individually or in combinations of two or more.

The following compounds can be given as examples of the hydroxyl group-containing (meth)acrylate compound used for the preparation of the urethane (meth)acrylate comprising the 12-hydroxystearic acid triglyceride or hydrogenated castor oil as a raw material: 2-hydroxyethyl(meth)acrylate, 2-hydroxypropyl(meth)acrylate, 2-hydroxybutyl(meth)acrylate, 2-hydroxy-3-phenyloxypropyl(meth)acrylate, 1,4-butanediol mono(meth)acrylate, 2-hydroxyalkyl(meth)acryloyl phosphate, 4-hydroxycyclohexyl(meth)acrylate, 1,6-hexanediol mono(meth)acrylate, neopentyl glycol mono(meth)acrylate, trimethylolpropane di(meth)acrylate, trimethylolethane di(meth)acrylate, pentaerythritol tri(meth)acrylate, dipentaerythritol penta(meth)acrylate, (meth)acrylate compounds shown by the following formula (3) or (4),

CH₂=C (R³)COOCH₂CH₂ (OCOCH₂CH₂CH₂CH₂CH₂)ₙOH (3)

CH₂=C(R³)COOCH₂CH (OH) CH₂O (C₆H₅) (4)

wherein R₃ is a hydrogen atom or methyl group and n indicates an integer from 1 to 15, and the compounds obtained by the addition reaction of a glycidyl group-containing compound (e.g. alkyl glycidyl ether, allyl glycidyl ether, and glycidyl (meth)acrylate) and (meth)acrylic acid. Of these hydroxyl group-containing (meth)acrylates, 2-hydroxyethyl (meth)acrylate, 2-hydroxypropyl (meth)acrylate, and the like are especially desirable.

These hydroxyl group-containing (meth)acrylate compounds may be used either individually or in combinations of two or more.

The proportion of the hydrogenated castor oil, diisocyanate, and hydroxyl group-containing (meth)acrylate used in the preparation of the urethane (meth)acrylate containing hydrogenated castor oil is determined so that for one mol of the hydroxyl group included in the hydrogenated castor oil, 0.2 to 3 mols, preferably 1 to 2 mols, of isocyanate group included in the diisocyanate compound and 0.2 to 1.5 mols, preferably 0.5 to 1 mol, of the hydroxyl group included in the hydroxyl group-containing (meth)acrylate compounds are used.

In the above reactions, a urethanization catalyst such as copper naphthenate, cobalt naphthenate, zinc naphthenate, di-n-butyltin dilaurate, triethylamine, 1,4-diazabicyclo[2.2.2]octane, and 2,6,7-trimethyl-1,4-diazabicyclo[2.2.2]octane is preferably used in an amount from 0.01 to 1 part by weight for 100 parts by weight of the total amount of the reactants. The reaction is carried out at a temperature from 10 to 900° C., and preferably 30 to 80° C., usually for 2 to 10 hours. The reaction is carried out preferably in the presence of a reactive diluent which is described later in this specification.

The urethane (meth)acrylate derived from a glyceride is used in the composition of the present invention in an amount from 10 to 90 wt %, and preferably from 20 to 80 wt %. If the amount of the urethane (meth)acrylate is less than 10 wt %, the water absorption of the cured products increases; if more than 90 wt %, the viscosity of the composition increases, whereby coatability of the composition is impaired and decrease in the productivity of optical fibers may result.

(Meth)acrylate monomer

It is desirable to add (meth)acrylate monomers to the composition of the present invention. Such (meth)acrylate monomers may be monofunctional monomers, bifunctional monomers, or polyfunctional monomers.

Given as examples of the monofunctional monomers of (meth)acrylate are alicyclic (meth)acrylates such as isobornyl(meth)acrylate, bornyl(meth)acrylate, tricyclodecanyl(meth)acrylate, dicyclopentanyl (meth)acrylate, dicyclopentenyl(meth)acrylate, and cyclohexyl(meth)acrylate; benzyl(meth)acrylate, 4-butylcyclohexyl(meth)acrylate, (meth)acryloylmorpholine, 2-hydroxyethyl(meth)acrylate, 2-hydroxypropyl(meth)acrylate, 2-hydroxybutyl(meth)acrylate, methyl(meth)acrylate, ethyl(meth)acrylate, propyl(meth)acrylate, isopropyl(meth)acrylate, butyl(meth)acrylate, amyl(meth)acrylate, isobutyl(meth)acrylate, t-butyl(meth)acrylate, pentyl(meth)acrylate, isoamyl(meth)acrylate, hexyl(meth)acrylate, heptyl(meth)acrylate, octyl(meth)acrylate, iso-octyl(meth)acrylate, 2-ethylhexyl(meth)acrylate, nonyl(meth)acrylate, decyl(meth)acrylate, isodecyl(meth)acrylate, undecyl(meth)acrylate, dodecyl(meth)acrylate, lauryl(meth)acrylate, stearyl(meth)acrylate, iso-stearyl (meth)acrylate, tetrahydrofurfuryl(meth)acrylate, butoxyethyl(meth)acrylate, ethoxydiethylene glycol (meth)acrylate, polyoxyethylenenonyl phenyl ether acrylate, phenoxyethyl(meth)acrylate, polyethylene glycol mono(meth)acrylate, polypropylene glycol mono(meth)acrylate, methoxyethylene glycol (meth)acrylate, ethoxyethyl (meth)acrylate, methoxypolyethylene glycol (meth)acrylate, methoxypolypropylene glycol (meth)acrylate, dimethylaminoethyl(meth)acrylate, diethylaminoethyl (meth)acrylate, 7-amino-3,7-dimethyloctyl(meth)acrylate, (meth)acrylates having a polyether skeleton of the following formula (5),

CH₂=C(R⁴)COO(R⁵O)ₘR⁶ (5)

wherein R⁴ is a hydrogen atom or methyl group, R⁵ is an alkylene group having 2-6, preferably 2-4, carbon atoms, R⁶ represents a hydrogen atom or an alkyl group having 1-12, preferably 1-9, carbon atoms, and m is an integer from 0 to 12, preferably from 1 to 8.

As examples of commercially available products of these monofunctional monomers, Aronix M-111, M-113, M-114, M-117 (manufactured by Toagosei Co., Ltd.), KAYARAD TC110S, R629, R644 (manufactured by Nippon Kayaku Co., Ltd.), IBXA (manufactured by Osaka Organic Chemical Industry Co., Ltd.), and the like can be given.

Of the above monofunctional monomers, isobornyl (meth)acrylate and polyoxyethylene nonylphenyl ether acrylate are desirable.

Given as examples of bifunctional monomers are ethylene glycol di(meth)acrylate, tetraethylene glycol di(meth)acrylate, polyethylene glycol di(meth)acrylate, 1,4-butanediol di(meth)acrylate, 1,6-hexanediol di(meth)acrylate, neopentyl glycol di(meth)acrylate, tris(2-hydroxyethyl)isocyanurate di(meth)acrylate, tricyclodecanedimethanol di(meth)acrylate, di(meth)acrylate of alkylene oxide addition diol of bisphenol A, di(meth)acrylate of alkylene oxide addition diol of hydrogenated bisphenol A, epoxy(meth)acrylate prepared by the addition of (meth)acrylate to diglycidyl ether of bisphenol A, and the like.

As examples of commercially available products of these bi-functional monomers, Yupimer UV, SA1002 (manufactured by Mitsubishi Chemical Corp.), Viscoat 700 (manufactured by Osaka Organic Chemical Industry Co., Ltd.), KAYARAD R-604, HX-620 (manufactured by Nippon Kayaku Co., Ltd.), Aronix M-210, M-215 (manufactured by Toagosei Co., Ltd.), and the like can be given.

Of the above bifunctional monomers, tricyclodecanedimethanol diacrylate and di(meth)acrylate of alkylene oxide addition diol of bisphenol A are particularly preferred.

As examples of polyfunctional monomers, trimethylolpropane tri(meth)acrylate, ethoxylated trimethylolpropane tri(meth)acrylate, propoxylated trimethylolpropane tri(meth)acrylate, pentaerythritol tri(meth)acrylate, pentaerythritol tetra(meth)acrylate, dipentaerythritol hexa(meth)acrylate, ditrimethylolpropane tetra(meth)acrylate, dipentaerythritolmonohydroxy penta(meth)acrylate, and the like can be given.

These polyfunctional monomers can be commercially available under the trademarks, for example, FA731A (manufactured by Hitachi Chemical Industries Co., Ltd.), Aronix M-315, M-350, M-360, M-405, M-450 (manufactured by Toagosei Co., Ltd.), KAYARAD DPHA, D-310, D-320, D-330, DPCA-20, DPCA-30, DPCA-60, DPCA-120 (manufactured by Nippon Kayaku Co., Ltd.), Viscoat #400 (manufactured by Osaka Organic Chemical Industry Co., Ltd.), and Photomer 4172, 4149 (manufactured by SAN NOPCO, Ltd.). Of these, Aronix M-450, Viscoat #400, and Photomer 4149 are particularly preferred.

The (meth)acrylate monomers affect viscosity of the composition and properties of the cured products and act as a solvent or a reactive diluent during the synthesis of the urethane (meth)acrylates. These reactive diluents may be used either individually or in combinations of two or more, and are usually added in an amount from 3 to 70 wt %, and preferably from 10 to 50 wt %, of the composition of the present invention. The use of the reactive diluents in this range ensures excellent coatability and curing speed of the composition, high toughness of the cured products, while minimizing the cure shrinkage rate.

N-Vinyl Group-Containing Monomer

It is desirable to add monomers containing an N-vinyl group (hereinafter called “N-vinyl group-containing monomers”) to the composition of the present invention. The N-vinyl group-containing monomers not only act as reactive diluents, but also increase the curing speed of the composition, if added in an appropriate amount. As examples of the monomers containing an N-vinyl group, N-vinylpyrrolidone, N-vinylcaprolactam, N-vinylformamide, N-vinylcarbazole, and the like can be given. The amount of the compound containing N-vinyl group is determined so that the amount of the N-vinyl group in the compound is two mols or less, preferably from 0.2 to 1 mol, for one mol of the (meth)acryloyl group contained in the composition. If the amount of the N-vinyl group is more than two mols, the curing speed of the composition decreases.

Other Urethane (Meth)Acrylates

The composition of the present invention may contain urethane (meth)acrylates other than the urethane (meth)acrylate prepared using 12-hydroxystearic acid triglyceride or hydrogenated castor oil as a raw material.

Conventionally known urethane acrylates prepared by reacting a hydroxyl group-containing (meth)acrylate and a polyisocyanate or reacting a hydroxyl group-containing (meth)acrylate, polyisocyanate, and polyol, for example, can be used as such a urethane (meth)acrylate.

Given as examples of the urethane acrylate obtained by the reaction of a hydroxyl group-containing (meth)acrylate and a polyisocyanate are a reaction product of hydroxyethy(meth)acrylate and 2,5-or 2,6-bis(isocyanatemethyl)-bicyclo [2.2.1]heptane, a reaction product of hydroxyethyl(meth)acrylate and 2,4-tolylene diisocyanate, a reaction product of hydroxyethyl(meth)acrylate and isophorone diisocyanate, a reaction product of hydroxypropyl (meth)acrylate and 2,4-tolylene diisocyanate, and a reaction product of hydroxypropyl(meth)acrylate and isophorone diisocyanate.

A polyether diol, polyester diol, polycarbonate diol, polycaprolactone diol, and the like can be given as the polyol used for preparing the urethane acrylate by the reaction of a hydroxyl group-containing (meth)acrylate, polyisocyanate, and polyol. The polyether diol includes aliphatic polyether diols, alicyclic diols, and aromatic diols. These polyols may be used either individually or in combinations of two or more. It is also possible to use a polyols with two or more valence obtained by the reaction of a diol and a polyisocyanate as the polyol. There are no specific limitations to the manner of polymerization of each structural unit in these polyols. Any one of random polymerization, block polymerization, and graft polymerization is acceptable.

As examples of the aliphatic polyether diol, polyethylene glycol, polypropylene glycol, polytetramethylene glycol, polyhexamethylene glycol, polyheptamethylene glycol, polydecamethylene glycol, and polyether diols produced by ring-opening copolymerization of two or more ion-polymerizable cyclic compounds can be given.

Given as examples of such ion-polymerizable cyclic compounds are cyclic ethers such as ethylene oxide, propylene oxide, butene-1-oxide, isobutene oxide, 3,3-bis(chloromethyl)oxetane, tetrahydrofuran, 2-methyltetrahydrofuran, 3-methyltetrahydrofuran, dioxane, trioxane, tetraoxane, cyclohexene oxide, styrene oxide, epichlorohydrin, glycidyl methacrylate, allyl glycidyl ether, allyl glycidyl carbonate, butadiene monoxide, isoprene monoxide, vinyloxetane, vinyltetrahydrofuran, vinylcyclohexene oxide, phenyl glycidyl ether, butyl glycidyl ether, and glycidyl benzoate.

Given as specific examples of polyether diols produced by the ring-opening copolymerization of ion-polymerizable cyclic compounds are binary copolymers produced by the combinations of, for example, tetrahydrofuran and propylene oxide, tetrahydrofuran and 2-methyl tetrahydrofuran, tetrahydrofuran and 3-methyl tetrahydrofuran, tetrahydrofuran and ethylene oxide, propylene oxide and ethylene oxide, and butene-1-oxide and ethylene oxide; and ternary copolymers produced by the combination of, for example, tetrahydrofuran, butene-1-oxide, and ethylene oxide.

A polyether diol obtained by the ring-opening copolymerization of the above-mentioned ion-polymerizable cyclic compound and a cyclic imine such as ethyleneimine, a cyclic lactone acid such as β-propyolactone and glycolic acid lactide, or a dimethylcyclopolysiloxane can also be used.

These aliphatic polyether diols are also commercially available under the trademarks, for example, PTMG 650, PTMG 1000, PTMG 2000 (manufactured by Mitsubishi Chemical Corp.), PPG400, PPG1000, EXCENOL720, 1020, 2020 (manufactured by Asahi Oline Co., Ltd.), PEG1000, Unisafe DC 1100, DC 1800 (manufactured by Nippon Oil and Fats Co., Ltd.), PPTG2000, PPTG1000, PTG400, PTGL2000 (manufactured by Hodogaya Chemical Co., Ltd.), and Z-3001-4, Z-3001-5, PBG2000A, PBG2000B, EO/BO4000, EO/BO2000 (manufactured by Daiichi Kogyo Seiyaku Co., Ltd.).

As examples of the alicyclic polyether diol, alkylene oxide addition diol of hydrogenated bisphenol A, alkylene oxide addition diol of hydrogenated bisphenol F, and alkylene oxide addition diol of 1,4-cyclohexane diol can be given.

As examples of the aromatic polyether diol, alkylene oxide addition diol of bisphenol A, alkylene oxide addition diol of bisphenol F, alkylene oxide addition diol of hydroquinone, alkylene oxide addition diol of naphthohydroquinone, and alkylene oxide addition diol of anthrahydroquinone can be given. These aromatic polyether diols can be commercially available under the trademarks, for example, Uniol DA400, DA700, DA1000, and DA4000 (manufactured by Nippon Oil and Fats Co., Ltd.).

As the polyester diol, polyester diols prepared by the reaction of a polyhydric alcohol and a polybasic acid can be given. Here, given as examples of the polyhydric alcohol are ethylene glycol, polyethylene glycol, propylene glycol, polypropylene glycol, tetramethylene glycol, polytetramethylene glycol, 1,6-hexanediol, neopentyl glycol, 1,4-cyclohexanedimethanol, 3-methyl-1,5-pentane diol, 1,9-nonane diol, and 2-methyl-1,8-octane diol. As example of the polybasic acid, phthalic acid, isophthalic acid, terephthalic acid, maleic acid, fumaric acid, adipic acid, sebacic acid, and the like can be given. As examples of commercially available products of polyester diols, Kurapol P-2010, P-1010, L-2010, L-1010, A-2010, A-1010, F-2020, F-1010, PMIPA-2000, PKA-A, PNOA-2010, PNOA-1010 (manufactured by Kuraray Co., Ltd.), and the like can be given.

As the polycarbonate diol, polycarbonate of polytetrahydrofuran, polycarbonate of 1,6-hexanediol, and the like can be given. Commercially available products of the polycarbonate diol include DN-980, 981, 982, 983 (manufactured by Nippon Polyurethane Industry Co., Ltd.), PC-8000 (manufactured by PPG), PC-THF-CD (manufactured by BASF), and the like.

As the polycaprolactone diol, polycaprolactone diols prepared by reacting ε-caprolactone and a diol can be given as examples. As the diol used in this reaction, ethylene glycol, polyethylene glycol, propylene glycol, polypropylene glycol, tetramethylene glycol, polytetramethylene glycol, 1,2-polybutylene glycol, 1,6-hexanediol, neopentyl glycol, 1,4-cyclohexanedimethanol, 1,4-butanediol, and the like can be given. These polycaprolactone diols are also commercially available under the trademarks, for example, PLACCEL 205, 205AL, 212, 212AL, 220, and 220AL (manufactured by Daicel Chemical Industries, Ltd.).

Other polyols which can be used include, for example, ethylene glycol, propylene glycol, 1,4-butanediol, 1,5-pentane diol, 1,6-hexanediol, neopentyl glycol, 1,4-cyclohexanedimethanol, hydrogenated bisphenol A, hydrogenated bisphenol F, dimethylol compound of dicyclopentadiene, tricyclodecanedimethanol, pentacyclodecanedimethanol, β-methyl-δ-valerolactone, polybutadiene with a terminal hydroxy group, hydrogenated polybutadiene with a terminal hydroxy group, polydimethylsiloxane with a diol terminal, and polydimethylsiloxane carbitol-modified polyol.

Among the above polyether polyols, polyester polyols, polycarbonate polyols, and polycaprolactone polyols, polyether polyols are desirable, because polyether polyols can produce polyurethanes with excellent durability and superior low temperature characteristics.

The following compounds can be given as examples of the diisocyanates used in the present invention: 2,4-tolylene diisocyanate, 2,6-tolylene diisocyanate, 1,3-xylylene diisocyanate, 1,4-xylylene diisocyanate, 1,5-naphthalene diisocyanate, m-phenylene diisocyanate, p-phenylene diisocyanate, 3,3′-dimethyl-4,4′-diphenylmethane diisocyanate, 4,4′-diphenylmethane diisocyanate, 3,3′-dimethylphenylene diisocyanate, 4,4′-biphenylene diisocyanate, 1,6-hexane diisocyanate, isophorone diisocyanate, methylenebis(4-cyclohexylisocyanate), 2,2,4-trimethylhexamethylene diisocyanate, bis(2-isocyanatethyl) fumarate, 6-isopropyl--1,3-phenyl diisocyanate, 4-diphenylpropane diisocyanate, lysine diisocyanate, hydrogenated diphenylmethane diisocyanate, hydrogenated xylylene diisocyanate, and tetramethylxylylene diisocyanate. Of these, 2,4-tolylene diisocyanate, isophorone diisocyanate, xylylene diisocyanate, methylenebis(4-cyclohexylisocyanate), and the like are preferable. These diisocyanates may be used either individually or in combinations of two or more.

The following compounds can be given as examples of the hydroxyl group containing (meth)acrylates used in the present invention: 2-hydroxyethyl(meth)acrylate, 2-hydroxypropyl(meth)acrylate, 2-hydroxybutyl(meth)acrylate, 2-hydoxy-3-phenyloxypropyl(meth)acrylate, 1,4-butanediol mono(meth)acrylate, 2-hydroxyalkyl(meth)acryloyl phosphate, 4-hydroxycyclohexyl(meth)acrylate, 1,6-hexanediol mono(meth)acrylate, neopentyl glycol mono(meth)acrylate, trimethylolpropane di(meth)acrylate, trimethylolethane di(meth)acrylate, pentaerythritol tri(meth)acrylate, dipentaerythritol penta(meth)acrylate, and (meth)acrylates shown by the above-mentioned formula (2) or (3). Of these hydroxyl group-containing (meth)acrylates, 2-hydroxyethyl (meth)acrylate, 2-hydroxypropyl (meth)acrylate, and the like are particularly preferred. In addition to these(meth)acrylates, compounds obtained by the addition reaction of a glycidyl group-containing compound such as an alkyl glycidyl ether, aryl glycidyl ether, or glycidyl (meth)acrylate and (meth)acrylic acid can also be used as the hydroxyl group-containing (meth)acrylate.

These hydroxyl group-containing (meth)acrylates may be used either individually or in combinations of two or more.

These urethane (meth)acrylates can be synthesized simultaneously as a mixture with the above-mentioned urethane (meth)acrylates which are prepared using hydrogenated castor oil as a raw material.

The proportion of the urethane (meth)acrylates prepared using hydrogenated castor oil as a raw material and the other urethane (meth)acrylates used in the composition of the present invention should preferably be determined so that the ratio P of the following formula (6) is from 0 to 0.7, and preferably from 0 to 0.6.

P=B/(A+B) (6)

wherein A is the amount (weight) of the urethane (meth)acrylates prepared using hydrogenated castor oil as a raw material and B is the amount (weight) of the other urethane (meth)acrylates. If P is more than 0.7, the cured products produced from the composition of the present invention exhibit increased water absorption.

The composition of the present invention can be cured by radiation. A photo-polymerization initiator can be used, if necessary. Here, radiation includes infrared radiation, visible rays, ultraviolet radiation, X-rays, electron beams, α-rays, β-rays, γ-rays, and the like.

Given as examples of photo-polymerization initiators which can be used in the present invention are 1-hydroxycyclohexyl phenyl ketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl dimethyl ketal, 1-(4-isopropylphenyl)-2-hydroxy-2-methylpropan-l-one, 2-hydroxy-2-methyl-1-phenylpropan-1-one, thioxanethone, diethylthioxanthone, 2-isopropylthioxanthone, 2-chlorothioxanthone, 2-methyl-1-[4-(methylthio)phenyl]-2-morpholino-propan-1-one, 2,4,6-trimethylbenzoyldiphenylphosphine oxide, bis-(2,6-dimethoxybenzoyl)-2,4,4-trimethylpentylphosphine oxide, and the like.

As commercially available products of photo-polymerization initiators, Irgacure 184, 369, 651, 500, 819, 907, CGI1700, CGI1750, CGI1850, CG24-61 (manufactured by Ciba Specialty Chemicals Co., Ltd.), Lucirin LR8728 (manufactured by BASF), Darocur 1116, 1173 (manufactured by Ciba Specialty Chemicals Co., Ltd.), Ubecryl P36 (manufactured by UCB), and the like can be given. Of these, Irgacure 184, Irgacure 651, Irgacure 907, Darocur 1173, and Lucirin LR 8728 are particularly preferred.

The amount of the photo-polymerization initiators used in the composition of the present invention is in the range from 0.1 to 10 wt %, and preferably from 0.5 to 7 wt %.

Other Components

Components other than the above-described components may be added to the composition of the present invention as required, inasmuch as the characteristics of the composition of the present invention are not adversely affected.

For instance, an amine compound may be added to the composition of the present invention to suppress generation of hydrogen gas which causes transmission loss of optical fibers. As such an amine compound, diallylamine, diisopropylamine, diethylamine, diethylhexylamine, and the like can be given.

Other additives which can be added in addition to the above-mentioned components include antioxidants, UV absorbers, light stabilizers, silane coupling agents, heat polymerization inhibitors, leveling agents, surfactants, preservatives, plasticizers, lubricants, coloring matters, solvents, fillers, aging preventives, wettability improvers, coating surface improvers, and the like.

As examples of antioxidants, Irganox 1010, 1035, 1076, 1222 (manufactured by Ciba Specialty Chemicals, Co., Ltd.), Antigen P, 3C, FR, GA-80 (manufactured by Sumitomo Chemical Industries Co., Ltd.), and the like can be given. As UV absorbers, Tinuvin P, 234, 320, 326, 327, 328, 329, 213 (manufactured by Ciba Specialty Chemicals Co., Ltd.), Seesorb 102, 103, 501, 202, 712, 704 (manufactured by Sypro Chemical Co., Ltd.), and the like can be given. As silane coupling agents, γ-aminopropyltriethoxy-silane, γ-mercaptopropyltrimethoxysilane, γ-methacryloxy-propyltrimethoxysilane, and commercially available products such as SH6062, SH6030 (manufactured by Toray-Dow Silicone Co., Ltd.), KBE903, 603, 403 (manufactured by Shin-Etsu Chemical Co., Ltd.), and the like can be given.

The composition of the present invention has a viscosity of preferably in the range from 200 to 20,000 cp, and more preferably from 1,000 to 16,000 cp, at 25° C. When the composition is used as a coating material for optical fibers, the use of the composition with a viscosity of more than 20,000 cp or less than 200 cp impairs coatability, which results in a decrease in the productivity of optical fibers.

Preferred composition include those wherein the cure speed, as measured by the ratio of Young's modulus of elasticity as described below) is greater than 0.10, and more preferably 20 or greater. If a N-vinyl monomer is present in the composition, the cure speed is preferably at least 20 and more preferably 30 or greater.

The radiation-curable compositions of the present invention may be formulated such that the composition after cure has a tensile modulus as low as 0.1 MPa and as high as 2,000 MPa or more. Those having a modulus in the lower range, for instance, from 0.1 to 10 MPa, preferably 0.1 to 5 MPa, and more preferably 0.5 to less than 3 MPa are typically suitable for inner primary coatings for fiber optics. In contrast, suitable compositions for outer primary coatings, inks and matrix materials generally have a modulus of above 50 MPa, with outer primary coatings tending to have a modulus more particularly above 100 up to 1,000 MPa and matrix materials tending to be more particularly between about 50 MPa to about 500 MPa.

Elongation and tensile strength of these materials can also be optimized depending on the design criteria for a particular us. For cured coatings formed from radiation-curable compositions formulated for use as inner primary coatings on optical fibers, the elongation-at-break is typically greater than 80%, more preferably the elongation-at-break is at least 110%, more preferably at least 150% but not typically higher than 400%. For coatings formulated for outer primary coatings, inks and matrix materials the elongation-at-break is typically between 10% and 100%, and preferably higher than 20%.

The glass transition temperature (Tg), measured as the peak tan-delta determined by dynamic mechanical analysis (DMA), can be optimized depending on the particulars of the application. The glass transition temperature may be from 10° C. down to −70° C. or lower, more preferably lower than −10° C. for compositions formulated for use as inner primary coatings and 10° C. to 120° C. or higher, more preferably above 30° C., for compositions designed for use as outer primary coatings, inks and matrix materials.

The composition of the present invention will preferably have a cure speed of 1.0 J/cm² or less (at 95% of maximum attainable modulus). For an inner, outer primary coating, ink or matrix material, cure speed is preferably about 0.5 J/cm² or less (at 95% of maximum attainable modulus), and more preferably, about 0.3 J/cm² or less, and even more preferably, about 0.2 J/cm² or less.

The cured products obtained by the polymerization of the resin composition of the present invention are particularly suitable for use as a coating material for optical fibers, optical fiber ribbons, and the like including primary coatings, secondary coatings, colored secodary coatings, inks, matrix materials and bundling materials.

### EXAMPLES

The present invention will be explained in more detail by way of examples, which are not intended to be limiting of the present invention.

### Example 1

A reaction vessel equipped with a stirrer was charged with 190 g of 2,4-tolylene diisocyanate, 0.17 g of 2,6-di- t-butyl-4-methylphenol as a polymerization inhibitor, 0.06 g of phenothiazine, 0.56 g of dibutyltin dilaurate, and 145 g isobornyl acrylate. After cooling the mixture with ice to 12° C., 127 g of 2-hydroxyethyl acrylate was added while maintaining the temperature at 25 to 30° C. After stirring for a further one hour at 23° C., 383 g of hydrogenated castor oil with a hydroxyl value of 159.5 (mg-KOH/g) and an iodine value of 2.1 (g I₂/100 g) (Caster Wax B, manufactured by Itoh Oil Chemicals Co., Ltd.) was added. The mixture was stirred for 6 hours at 70° C. before terminating the reaction. Then, 122 g of N-vinylpyrrolidone, 30 g of Irgacure 651 (a photo-polymerization initiator), and 3 g of Irganox 1035 (an antioxidant) were added to the resulting product. The mixture was stirred for two hours at 55° C. to obtain 1,000 g of the composition of the present invention.

The hydrogenation rate of the hydrogenated castor oil used was calculated to be 97.5-97.6% by applying the known iodine value of castor oil (83-89 g I₂/100 g) to the following formula.

Hydrogenation rate (%)=(1−iodine value of hydrogenated castor oil/iodine value of castor oil)×100

### Example 2

1000 g of the composition of the present invention was prepared in the same manner as in Example 1, except that the amount of isobornyl acrylate used was 94 g and that of N-vinylpyrrolidone was 173 g.

### Example 3

1,000 g of the composition of the present invention was prepared in the same manner as in Example 1, except the amount of isobornyl acrylate used was 207 g and that of N-vinylpyrrolidone was 60 g.

### Example 4

1,000 g of the composition of the present invention was prepared in the same manner as in Example 1, except that the amount of isobornyl acrylate used was 267 g and no N-vinylpyrrolidone was added.

### Example 5

A reaction vessel equipped with a stirrer was charged with 172 g of 2,4-tolylene diisocyanate, 1.4 g of 2,6-di- t-butyl-4-methylphenol as a polymerization inhibitor, 0.5 g of phenothiazine, 0.43 g of dibutyltin dilaurate, and 145 g isobornyl acrylate. After cooling the mixture with ice to 12° C., 114.5 g of 2-hydroxyethyl acrylate was added while maintaining the temperature below 30° C. After stirring for a further one hour at 23° C., 191.5 g of hydrogenated castor oil (Caster Wax B) and 220 g of tetramethylene glycol (PTMG 1000) were added. The mixture was stirred for 6 hours at 70° C. before terminating the reaction. Then, 122 g of N-vinylpyrrolidone, 30 g of Irgacure 651, and 3 g of Irganox 1035 were added to the resulting product. The mixture was stirred for two hours at 55° C. to obtain 1,000 g of the composition of the present invention.

### Example 6

A reaction vessel equipped with a stirrer was charged with 190 g of 2,4-tolylene diisocyanate, 0.17 g of 2,6-di-t-butyl-4-methylphenol as a polymerization inhibitor, 0.06 g of phenothiazine, 0.56 g of dibutyltin dilaurate, and 145 g isobornyl acrylate as a reactive diluent. After cooling the mixture with ice to 12° C., 127 g of 2-hydroxyethyl acrylate was added while maintaining the temperature at 25-30° C. After stirring for a further one hour at 23° C., 383 g of hydrogenated castor oil with a hydroxyl value of 160.3 (mg-KOH/g), an iodine value of 2.0 (g I₂/100 g), and a hydrogenation rate of 98% (Caster Wax, manufactured by Itoh Oil Chemicals Co., Ltd.) was added. The mixture was stirred for 6 hours at 70° C. before terminating the reaction. Then, 122 g of N-vinylpyrrolidone, 30 g of Irgacure 651 (a photo-polymerization initiator), and 3 g of Irganox 1035 (an antioxidant) were added to the resulting product. The mixture was stirred for two hours at 55° C. to obtain 1,000 g of the composition of the present invention.

### Comparative Example 1

A reaction vessel equipped with a stirrer was charged with 192 g of 2,4-tolylene diisocyanate, 0.17 g of 2,6-di-t-butyl-4-methylphenol as a polymerization inhibitor, 0.06 g of phenothiazine, 0.56 g of dibutyltin dilaurate, and 145 g isobornyl acrylate. After cooling the mixture with ice to 12° C., 128 g of 2-hydroxyethyl acrylate was added while maintaining the temperature below 30° C. After stirring for a further one hour at 23° C., 380 g of castor oil with a hydroxyl value of 163.0 (mg-KOH/g) and an iodine value of 85.7 (g I₂/100) (Caster Oil LAV, manufactured by Itoh Oil Chemicals Co., Ltd.) was added. The mixture was stirred for 6 hours at 70° C. before terminating the reaction. Then, 122 g of N-vinylpyrrolidone, 30 g of Irgacure 651, and 3 g of Irganox 1035 were added to the resulting product. The mixture was stirred for two hours at 55° C. to obtain 1,000 g of a comparative composition.

### Comparative Example 2

A reaction vessel equipped with a stirrer was charged with 154 g of 2,4-tolylene diisocyanate, 1.4 g of 2,6-di-t-butyl-4-methylphenol, 0.5 g of phenothiazine, 0.43 g of dibutyltin dilaurate, and 145 g isobornyl acrylate. After cooling the mixture with ice to 12° C., 103 g of 2-hydroxyethyl acrylate was added while maintaining the temperature below 30° C. After stirring for a further one hour at 23° C., 441 g of tetramethylene glycol (PTMG 1000) was added. The mixture was stirred for 6 hours at 70° C. before terminating the reaction. Then, 122 g of N-vinylpyrrolidone, 30 g of Irgacure 651, and 3 g of Irganox 1035 were added to the resulting product. The mixture was stirred for two hours at 55° C. to obtain 1,000 g of a comparative composition.

### Comparative Example 3

A reaction vessel equipped with a stirrer was charged with 217 g of 2,4-tolylene diisocyanate, 1.4 g of 2,6-di-t-butyl-4-methylphenol, 0.5 g of phenothiazine, 0.43 g of dibutyltin dilaurate, and 145 g isobornyl acrylate. After cooling the mixture with ice to 12° C., 230 g of 2-hydroxyethyl acrylate was added while maintaining the temperature below 30° C. After stirring for a further one hour at 23° C., 253 g of tetramethylene glycol (PTMG 1000) was added. The mixture was stirred for 6 hours at 70° C. before terminating the reaction. Then, 122 g of N-vinylpyrrolidone, 30 g of Irgacure 651, and 3 g of Irganox 1035 were added to the resulting product. The mixture was stirred for two hours at 55° C. to obtain 1,000 g of a comparative composition.

### Comparative Example 4

1000 g of a comparative composition was prepared in the same manner as in Comparative Example 3, except that the amount of isobornyl acrylate used was 267 g and N-vinylpyrrolidone was not added.

Test Methods

The viscosity and curing speed of the compositions prepared in Examples 1-5 and Comparative Examples 1-4, and Young's modulus of elasticity and water absorption of the cured products produced from the compositions were measured according to the following methods. The results are shown in Table 1.

Measurement of Viscosity

The viscosity was measured at 25° C. using a B-type viscometer manufactured by Tokyo Keiki Co., Ltd.

Curing Speed of the Composition and Properties of the Cured Products

1. Preparation of Test Specimens

The photocurable resin composition was applied on a glass plate using an applicator bar and irradiated with ultraviolet radiation at a dose of 0.01 J/cm² or 0.1 J/cm² using a UV curing system(jet printer HMW 312MX, manufactured by ORC Manufacturing Co., Ltd.) in an nitrogen atmosphere to produce cure films with a thickness of 200 μm. The cured films were peeled from the glass plate and allowed to stand for 24 hours at a temperature of 23° C. and a relative humidity of 50%, thereby obtaining a test specimen.

### 2. Measurement of Young's Modulus of Elasticity

The test specimen was cut into strips with a width of 6 mm to measure Young's modulus of elasticity at 23° C. according to the JIS K7113 using an autograph AGS-1LKND (manufactured by Shimazu Corporation), provided that the tensile velocity was 1 mm/min. The Young's modulus of elasticity was calculated from tensile stress at 2.5% distortion.

3. Calculation of Curing Speed

The ratio of Young's modulus of elasticity of the film cured by 0.01 J/cm² UV irradiation and that of the film cured by 0.1 J/cm² UV irradiation was calculated. This ratio was taken as the curing speed.

4. Measurement of Water Absorption

The liquid curable resin composition was applied to a glass plate using an applicator bar with a thickness of 250 μm and cured with ultraviolet radiation at a dose of 1.0 J/cm² in the air. The cured product was conditioned for more than 12 hours at a room temperature of 23° C. and a relative humidity of 50%, and peeled off from the glass plate to obtain a test specimen. Water absorption of the cured product was measures according to the JIS K7209.

TABLE 1

| | Example | | | | | | Comparative Example | | | |
|---|---|---|---|---|---|---|---|---|---|---|
| | 1 | 2 | 3 | 4 | 5 | 6 | 1 | 2 | 3 | 4 |
| Urethane acrylate prepared | 70 | 70 | 70 | 70 | 35 | — | — | — | — | — |
| using hydrogenated castor oil | | | | | | | | | | |
| (Caster Wax B) | | | | | | | | | | |
| Urethane acrylate prepared | — | — | — | — | — | 70 | — | — | — | — |
| using hydrogenated castor oil | | | | | | | | | | |
| (Caster Wax) | | | | | | | | | | |
| Urethane acrylate prepared | — | — | — | — | — | — | 70 | — | — | — |
| using castor oil (Caster oil | | | | | | | | | | |
| LAV) | | | | | | | | | | |
| Polyether urethane acrylate | — | — | — | — | 35 | | — | 70 | 40 | 40 |
| Urethane acrylate (bis(2- | — | — | — | — | — | — | — | — | 30 | 30 |
| acryloxyethyl)-2,4-tolylene | | | | | | | | | | |
| carbamate) | | | | | | | | | | |
| Isobornyl acrylate | 14.5 | 9.4 | 20.7 | 26.7 | 14.5 | 14.5 | 14.5 | 14.5 | 14.5 | 26.7 |
| N-vinylpyrrolidone | 12.2 | 17.3 | 6.0 | — | 12.2 | 12.2 | 12.2 | 12.2 | 12.2 | — |
| Irgacure 651 | 3.0 | 3.0 | 3.0 | 3.0 | 3.0 | 3.0 | 3.0 | 3.0 | 3.0 | 3.0 |
| Irganox 1035 | 0.3 | 0.3 | 0.3 | 0.3 | 0.3 | 0.3 | 0.3 | 0.3 | 0.3 | 0.3 |
| Viscosity at 25° C. (cps) | 7500 | 5000 | 8600 | 9800 | 8300 | 7400 | 7500 | 4400 | 15000 | 16000 |
| Young's modulus (kg/mm²) | | | | | | | | | | |
| UV irradiation | | | | | | | | | | |
| 0.01 (J/cm²): a | 34 | 45 | 18 | 10 | 35 | 35 | *N/C | 3 | 8 | 5 |
| 0.1 (J/cm²): b | 92 | 89 | 86 | 86 | 93 | 92 | 22 | 14 | 87 | 70 |
| Curing speed: a/b | 0.37 | 0.50 | 0.20 | 0.12 | 0.38 | 0.38 | — | 0.21 | 0.09 | 0.07 |
| Water absorption of cured | 1.4 | 2.2 | 0.9 | 0.4 | 2.5 | 1.3 | 1.5 | 3.6 | 3.7 | 3.0 |
| product (%) | | | | | | | | | | |

The viscosity of both the compositions in Examples and Comparative Examples was in the preferable range from 4,400 to 16,000 cp. The composition of the Comparative Example 1 was prepared in the same manner as in the composition of Example 1, except for using the urethane (meth)acrylate which was prepared using unhydrogenated castor oil. This comparative composition do not cure (*N/C) at the 0.01 (J/cm²) dose and exhibited only an extremely low photo-curing speed. The composition of the Comparative Examples 2, 3, and 4 were prepared using a conventional urethane (meth)acrylate instead of the urethane (meth)acrylate of the present invention prepared using hydrogenated castor oil. These compositions exhibited only a small curing speed and the cured products made from these compositions exhibited high water absorption. The composition of Example 2 exhibited low water absorption of 2.2%, in spite of the large content (17.3 wt %) of N-vinylpyrrolidone which tends to increase water absorption. These experimental results demonstrate the effect of the photocurable resin composition of the present invention comprising the urethane (meth)acrylate which is prepared by using the hydrogenated castor oil as a raw material. In addition, the preferred composition are those wherein the water absorption of the cured composition is less than 3.0%, as measured by the method set forth below, more preferably 2.5% or less and when N-vinyl monomers are not present less than 1.0%, and preferably less than 0.5%.

Because the photocurable resin composition of the present invention can be applied at a high speed due to its moderate viscosity and is photocurable at a high speed, the composition can exhibit high productivity when used as a coating material for optical fibers. In addition, because the cured products is only slightly affected by water due to their small water absorption, the composition is an ideal coating material for optical fibers.

1. Use of a photocurable coating composition comprising a (meth)acrylate urethane compound derived at least in part from at least one fatty acid glvceride compound wherein said glyceride compound comprises at least on average at least 1.5 hydroxy groups in the production of fiber optics.

2. Use according to claim 1 wherein said fatty acid glyceride compound comprises three fatty acid moieties.

3. Use according to any one of claims 1-2, wherein the (meth) acrylate urethane compound has an ethylenic unsaturation between 2 and 5.

4. Use according to any one of claims 1-3 wherein the hydrogenation rate of the fatty acid glyceride is at least 20% or more.

5. Use according to any one of claims 1-4 wherein the fatty acid includes a stearic acid, linolic acid, oleic: acid, palmatic acid and/or ricinolic acid.

6. Use according to any one of claims 1-5 wherein the fatty acid glyceride comprises 2-5 hydroxy groups.

7. Use according to any one of claims 1-6 wherein the at least one fatty acid glyceride includes a glyceride represented by the following formula (2):

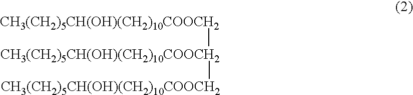

8. Use according to any one of claims 1-7 wherein the (meth)acrylate urethane compound is derived from a hydrogenated castor oil, comprising the at least one fatty acid glyceride.

9. Use according to any one of claims 1-7 wherein the (meth)acrylate urethane compound is a polyfunctional compound comprising at least two (meth)acrylate-containing groups linked via a urethane group to a residue of the fatty acid glyceride.

10. Use according to any one of claims 1-9 wherein the composition further comprises a moromer having an N-vinyl group.

11. An optical fiber comprisng a cured coating composition according to any one of claims 1-10.

12. The optical fiber according to claim 11, wherein the cured coating composition is a primary coating, secondary coating, colored secondary coating, matrix material, or ink.

13. Use of a photocurable coating composition according to anyone of claims 1-10 obtainable by forming the (meth)acrylate urethane compound by reacting the at least one fatty acid glyceride with a diisocyanate and a (meth)acrylate containing a hydroxyl group.
